(19) United States
(12) Patent Application Publication
(10) Pub. No.: US 2012/0228887 A1
(43) Pub. Date: Sep. 13, 2012

(54) DOOR FRAME SECURITY DEVICE

(76) Inventor: Terry G. McMullen, Langley (CA)

(21) Appl. No.: 13/413,886

(22) Filed: Mar. 7, 2012

(30) Foreign Application Priority Data
Mar. 8, 2011 (CA) 2734140

(51) Int. Cl. E05B 15/02

(52) U.S. Cl. 292/340

(57) ABSTRACT

There is provided a door frame security device, the frame having an inside portion and an outside portion with a strike plate affixed thereto, the strike plate mating with a bolt of the door as the bolt passes through it and a bolt bore in the door frame. The door frame security device includes a security plate adapted to be affixed to the inside portion of the door frame before installing the door frame. A reinforcing device for reinforcing the bolt bore may be interdependent with and extend from the security plate and may be positioned in-line and placed through the bolt bore. When the door is locked, the bolt passes through the strike plate and the bolt bore in the door frame and engages the reinforcing device that extends from the security plate. The bolt, security plate and reinforcing device jointly resist impact forces on the door.

### BACKGROUND OF THE INVENTION

1. Field of Invention

The invention relates to the field of security devices and in particular to a door frame security device that may be affixed to a door frame prior to installation.

2. Description of Related Art

Conventional door frames are manufactured from soft wood, such as pine. Pine, and these types of wood, are economical to use and easy to shape. On the downside, conventional door frames made of such materials easily wear from friction and are easily flexed when forces are applied to them.

Due to the inherent nature of wooden door frames, these door frames are particularly vulnerable to break-ins from someone applying a lateral force to a door, such as from a kick. A door frame is particularly vulnerable at its weakest part, the door bolt bore.

Numerous devices have been previously proposed for reinforcing a wooden door frame, and many of these devices have achieved varying degrees of success. However, such devices are either externally mounted to the door frame thereby affecting their operation and aesthetic appearance of the door, or they are mounted on the door frame such that forces exerted on the door are not effectively distributed across the door frame.

Accordingly, a need exists for a door frame security device which is internally mountable and which will effectively distribute forces exerted on the door frame during an attempted forced entry. Other objects of the invention will be apparent from the description that follows.

### SUMMARY OF THE INVENTION

According to the present invention there is provided a door frame security device. Typically, a door frame includes an inside and an outside portion. The outside portion of the door frame generally has a strike plate affixed thereto. The strike plate is generally adapted to mate with a bolt of the door as the bolt passes through it and a bolt bore in the door frame.

The door frame security device may include a security plate adapted to be affixed to the inside portion of the door frame before the door frame is installed within an opening of a wall. The door frame security device may also include a reinforcing device for reinforcing the bolt bore which is adapted to be interdependent with and extend from the security plate. The reinforcing device may extend from the security plate so that it is in-line with and placed through the bolt bore when the plate is affixed to the door frame. Additionally, the reinforcing device may be dimensioned so that it engages the bolt when in operation.

The reinforcing device may be a tab member that extends perpendicularly from the security plate.

The security plate may include a through-hole adapted to receive a fastener to affix it to the inside portion of the door frame. It may also include a through-hole adapted to receive a security fastener used to affix the strike plate to the outside portion of the door frame. Additionally, the security plate may also include a through-hole adapted to receive the bolt.

The security plate and the reinforcing device may be comprised of a unitary material such as steel. Preferably, the steel is galvanized.

When the door is locked, the bolt passes through the strike plate and the bolt bore. The bolt then engages the reinforcing device which extends from the security plate. As such, the bolt, the security plate and the reinforcing device jointly act to resist any impact forces applied to the door. Additionally, the bolt, the strike plate, the security fastener, the security plate and the reinforcing device together form an integrated and connected structural body around the bolt bore to strengthen the bolt bore area.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is an exploded perspective view of the door frame security device for installation in a door frame;

FIG. 2 is a plan view of the door frame security device of FIG. 1;

FIG. 3 is a top view of the door frame security device of FIG. 2; and

FIG. 4 is an exploded perspective view of a door frame security device for installation in a t-bar door frame.

### DESCRIPTION OF THE PREFERRED EMBODIMENT OF THE INVENTION

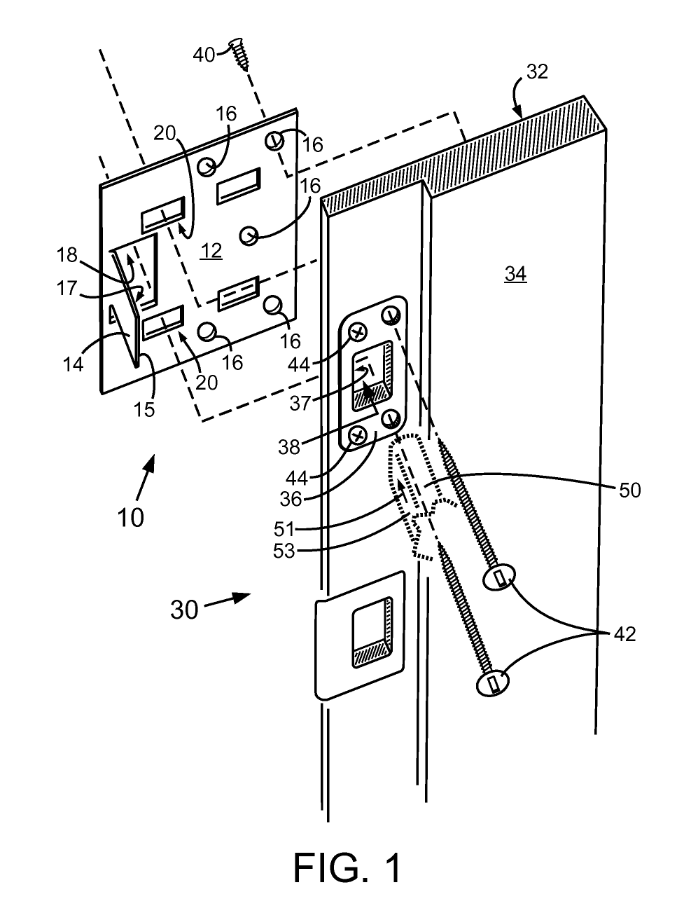

Referring to FIG. 1, there is provided a door frame security device 10 according to the present invention. Security device 10 includes a substantially flat security plate 12 which is adapted to be affixed to a door frame 30. The door frame 30 typically includes an inside portion 32 and an outside portion 34 and is used to frame a door (not depicted). The door typically includes a door bolt 50 which passes along line 51 through a strike plate 36 and is received by a bolt bore 38 in the door frame 30.

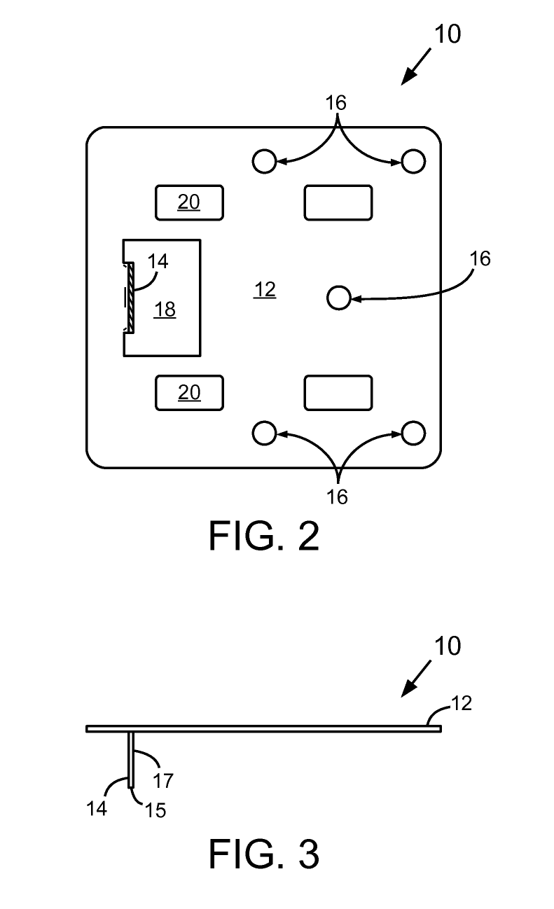

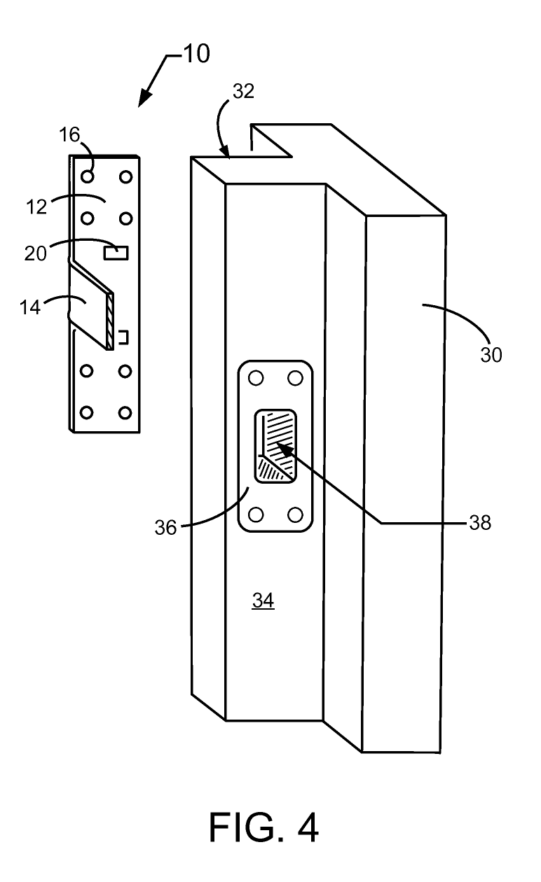

Referring to FIG. 2, security plate 12 is generally rectangular in shape with an overall length of 9.5 cm and width of 10 cm. As those skilled in the art will appreciate, the dimensions of security plate 12 may significantly vary depending upon various door frame sizes and applications. For example, referring to FIG. 4, a security device 10 is affixed to a t-bar door frame 30. In this application, the security device's 10 length is significantly longer than its width to accommodate the t-bar door frame 30.

Referring back to FIG. 1, security device 10 also includes means for reinforcing the bolt bore 38 of the frame 30. The reinforcing means is adapted to be interdependent with and extend from the security plate 12. Referring to FIG. 3, preferably, reinforcing means includes a substantially flat tab member 14 which extends perpendicularly from the security plate 12. As those skilled in the art will appreciate, reinforcing means may be any suitable device that extends from and is interdependent with the security plate 12. For example, reinforcing means may include a finger, channel or lip extending from the security plate 12.

Referring back to FIG. 1, tab member 14 is dimensioned and extends from the security plate 12 so that it is in-line with and placed through the bolt bore 38 when the security device 10 is installed in the door frame 30. Additionally, tab member 14 is dimensioned so that in operation it receives the door bolt 50 and its tip 15 reaches no further than the back 37 of the strike plate 36. For most applications, tip member 14 will be generally rectangular in shape with a overall length of 1.5 cm and width of 2 cm. As those skilled in the art will appreciate, the dimensions of the tip member 14 may significantly vary depending upon various bolt bore sizes and may be on either side of through-hole 18.

To affix the security plate 12 to the inside portion 32 of the door frame 30, the security plate includes a through-hole 16 which is adapted to receive a fastener 40 such as a nail or screw. Preferably, through-hole 16 is dimensioned to receive a ⅜ or ¾ screw. As those skilled in the art will appreciate, security plate 12 may include a single or a plurality (as depicted) of through-holes 16. Through-holes 16 may be placed anywhere through the security plate 12 to reasonably affix the security plate to the door frame 30.

The security plate 12 may also include a through-hole 18 adapted to receive the door bolt 50 as it passes through the bolt bore 38. As depicted, through-hole 18 is placed adjacent tab member 14. As those skilled in the art will appreciate, through-hole 18 may be dimensioned to accommodate any size door bolt.

Additionally, the security plate 12 may also include a through-hole 20 which is adapted to receive a 3″ security fastener 42 used to affix the strike plate 36 to the outside portion 34 of the door frame 30. Through-hole 20 may be a traditional round hole or may be a slotted hole as depicted. As those skilled in the art will appreciate, a slotted hole enables the security device 10 to accommodate a variety of door frame and strike plate combinations.

Preferably, the security plate 12 and the tab member 14 are comprised of a unitary material such as common grade steel or galvanized 16 gauge steel. As those skilled in the art will appreciate any suitably rigid material may be used. Preferably, security plate 12 may easily be formed from a stamping of sheet metal. Similarly through-holes 16, through holes 18 and through hole 20 may easily be punched through security plate 12. Preferably, through-hole 18 is simply formed by firstly cutting the shape of tab member 14 into the steel security plate 12. Before operation of the security device 10, tab member 14 may be bent back to lie perpendicular to the security plate 12 leaving behind through-hole 18.

### Operation

Before installing the door frame 30 into an opening of a wall, the security device 10 is affixed to the inside portion 32 of the door frame. The inside portion 32 should generally be smooth so that the security device 10 sits flush against it. As such, inside portion 32 may require sanding before the security device 10 is affixed to the door frame 30.

Once the inside portion 32 of the door frame 30 has been prepared to receive the security device 10, the security device may be affixed to the door frame with fasteners 40 placed through through-holes 16. During this step, tab member 14 should be aligned with and pass through bolt bore 38. Additionally, tab member 14 should sit as flush to the wall of the bolt bore 38 so that when in operation the bolt may slide easily through the bolt bore while still engaging the tab member.

After the security device 10 has been properly affixed to the door frame 30, the door frame may now be installed into the wall opening with conventional means. The strike plate 36 is then affixed to the outside portion 34 of the door frame 30 with conventional fasteners 44. During this step the strike plate 36 should be aligned with the tab member 14 to ensure smooth operation of the bolt 50 through the bolt bore 38.

Security fastener 42 may then be used to further secure the strike plate 36 to the door frame 30. Security fastener 42 is generally a 3″ screw used to penetrate into the wall that houses the door frame 30. With security device 10 installed, security fastener 42 now passes through the strike plate 36 and the door frame 30 and is received by through-hole 20 thereby creating a connection between strike plate 36 and security device 10.

After the door frame 30 and door have been properly installed in the wall opening the door can be locked by sliding the door bolt 50 along line 51 into the bolt bore 38. In the locked position, the bolt 50 engages the tab member 14 along its side portion side 53. In turn, tab member 14 engages the bolt 50 along its side portion 17. Thus, the bolt 50, the security plate 12 and the tab member 14 are in contact with one-another in the locked position and can jointly act to resist any impact forces applied to the door. Furthermore, when the door is locked, the bolt 50, the strike plate 36 the security fastener 42, the security plate 12 and the tab member 14 together form an integrated and connected structural body to strengthen the area around the bolt bore.

It will thus be seen that a new and novel door frame security device has been illustrated and described and it will be apparent to those skilled in the art that various changes and modifications may be made therein without departing from the spirit of the invention.

What is claimed is:

1. A door frame security device, the door frame having an inside and an outside portion, the outside portion having a strike plate affixed thereto, the strike plate being adapted to mate with a bolt of the door as the bolt passes through it and a bolt bore in the door frame, the door frame security device comprising:
a security plate adapted to be affixed to the inside portion of the door frame before the door frame is installed within an opening of a wall; and
means for reinforcing the bolt bore, said reinforcing means adapted to be interdependent with and extend from said security plate and positioned in-line and through the bolt bore when said security plate is affixed to the door frame;
wherein when the door is locked, the bolt passes through the strike plate and the bolt bore and engages said reinforcing means which extends from said security plate, thereby the bolt, said security plate and said reinforcing means jointly act to resist any impact forces applied to the door.

2. The door frame security device of claim 1 wherein said means for reinforcing the bolt bore comprises a tab member extending perpendicularly from said security plate.

3. The door frame security device of claim 1 wherein said security plate further comprises a through-hole adapted to receive a fastening means to affix said security plate to the inside portion of the door frame.

4. The door frame security device of claim 1 wherein said security plate further comprises a through-hole adapted to receive a security fastening means used to affix the strike plate to the outside portion of the door frame.

5. The door frame security device of claim 1 wherein said security plate further comprises a through-hole adapted to receive the bolt.

6. The door frame security device of claim 1 wherein said security plate and said means for reinforcing the door frame are comprised of a unitary material.

7. The door frame security device of claim 6 wherein said material comprises steel.

8. The door frame security device of claim 7 wherein said steel is galvanized.

9. A door frame security device, the door frame having an inside and an outside portion, the outside portion having a strike plate affixed thereto, the strike plate being adapted to mate with a bolt of the door as the bolt passes through it and a bolt bore in the door frame, the door frame security device comprising:
a security plate adapted to be affixed to the inside portion of the door frame before the door frame is installed within an opening of a wall; and
a tab member adapted to be interdependent with and extend perpendicularly from said security plate and positioned in-line and through the bolt bore when said security plate is affixed to the door frame;
wherein when the door is locked, the bolt passes through the strike plate and the bolt bore and engages said tab member which extends from said security plate, thereby the bolt, said security plate and said tab member jointly act to resist any impact forces applied to the door.

10. The door frame security device of claim 9 wherein said security plate further comprises a through-hole adapted to receive a fastening means to affix said security plate to the inside portion of the door frame.

11. The door frame security device of claim 9 wherein said security plate further comprises a through-hole adapted to receive a security fastening means used to affix the strike plate to the outside portion of the door frame.

12. The door frame security device of claim 9 wherein said security plate further comprises a through-hole adapted to receive the bolt.

13. The door frame security device of claim 9 wherein said security plate and said tab member are comprised of a unitary material.

14. The door frame security device of claim 13 wherein said material comprises steel.

15. The door frame security device of claim 14 wherein said steel is galvanized.

16. A door frame security device, the door frame having an inside and an outside portion, the outside portion having a strike plate affixed thereto, the strike plate being adapted to mate with a bolt of the door as the bolt passes through it and a bolt bore in the door frame, the door frame security device comprising:
a security plate adapted to be affixed to the inside portion of the door frame before the door frame is installed within an opening of a wall; and
a tab member adapted to be interdependent with and extend perpendicularly from said security plate and positioned in-line and through the bolt bore when said security plate is affixed to the door frame;
said security plate further comprising a through-hole adapted to receive a fastening means to affix said security plate to the inside portion of the door frame;
wherein when the door is locked, the bolt passes through the strike plate and the bolt bore and engages said tab member which extends from said security plate, thereby the bolt, said security plate and said tab member jointly act to resist any impact forces applied to the door.

17. The door frame security device of claim 16 wherein said security plate further comprises a through-hole adapted to receive a security fastening means used to affix the strike plate to the outside portion of the door frame.

18. The door frame security device of claim 16 wherein said security plate further comprises a through-hole adapted to receive the bolt.

19. The door frame security device of claim 16 wherein said security plate and said tab member are comprised of a unitary material.

20. The door frame security device of claim 19 wherein said material comprises galvanized steel.
